(19) United States
(12) Patent Application Publication
(10) Pub. No.: US 2011/0098922 A1
(43) Pub. Date: Apr. 28, 2011

(54) Path Predictive System And Method For Vehicles

(75) Inventor: Faroog Abdel-Kareem Ibrahim, Dearborn Heights, MI (US)

(73) Assignee: VISTEON GLOBAL TECHNOLOGIES, INC., Van Buren Township, MI (US)

(21) Appl. No.: 12/606,229

(22) Filed: Oct. 27, 2009

(51) Int. Cl. G01C 21/26

(52) U.S. Cl. 701/208

(57) ABSTRACT

A system that uses a map database as a predictive sensor and more specifically to a system and method of using a map database as a path predictive vehicle sensor or input with the additional ability to identify system related point of interests, or detect and internally correct for errors in the map database that are found during operation of the vehicle as well as preemptively identifying problematic errors in the database that may create false negatives, or sometimes false positives when combined with a warning system such as a form of a stability system, crash avoidance system, or crash warning system.

### BACKGROUND OF THE INVENTION

1. Technical Field

The present invention is directed to a system that uses a map database as a predictive sensor and more specifically to a system and method of using a map database as a path predictive vehicle sensor or input with the additional ability to identify system related point of interests, or detect and internally correct for errors in the map database that are found during operation of the vehicle as well as preemptively identifying problematic errors in the database that may create false negatives, or sometimes false positives when combined with a warning system such as a form of a stability system, crash avoidance system, or crash warning system.

2. Discussion

Many modern vehicles include accurate real time positioning systems, commonly known as GPS navigation systems, to provide position information as well as directions to a destination using a map database. These positioning systems while commonly used, generally do not provide any information to the vehicle, and in particular do not provide information to built-in warning systems, vehicle stability systems, anti-skid programs, or other safety systems. Generally these map or navigation systems only provide turn-by-turn directions and do not provide any information to the operator of the vehicle, in particular, information about upcoming road conditions such as curves, bends, divided highways, or merges.

Many vehicles include various driver awareness systems, vehicle stability systems and collision avoidance or mitigation systems. While these awareness, stability, avoidance or mitigation systems are known by different names for different manufacturers, they all attempt to increase the safety of the vehicle by warning the operator of pending issues or even actively controlling the vehicle to improve the safety of the vehicle by minimizing or preventing loss of control of the vehicle. These safety systems use a variety of inputs or sensors to determine when corrective action is required or when the operator should be notified of an existing or an imminent safety condition. One disadvantage to these systems is that they are limited in their ability to predict upcoming conditions, and in particular, are not able to warn the operator or prepare to take actions for conditions that are not within visual range of the operator of the vehicle.

As an example, for vehicles equipped with some form of a stability control system, such as those configured to minimize loss of control around corners or curves, modern systems are only able to be reactive to current conditions such as when the vehicle is within the curve. Reactive corrections may be too late to perform sufficient corrective action. More specifically, these systems cannot warn the operator of a vehicle that the vehicle is approaching an upcoming curve too quickly such that upon entering the curve, there is a risk that the vehicle may experience a loss of control. Without such a warning, the vehicle may enter the curve too quickly and even though the vehicle may take corrective action once a potential safety condition is identified, such as by applying the brakes, reducing throttle input and more based upon sensor input data that loss of control is eminent, the corrective action may be too little and too late and the vehicle will experience a loss of control. More specifically, the basic laws of physics may prevent the system from providing sufficient corrective action to maintain control of the vehicle. Therefore, the effect of these safety systems is limited to reactive corrections which are not always possible particularly on less than ideal conditions, such as ice or snow, and are not always capable of providing sufficient correction to avoid loss of control. Beyond taking preemptive actions, current systems are also incapable of providing predictive warnings to the vehicle operator based upon upcoming road segments such as curves. The map based predictive path can have a significant positive impact on the performance of systems such as Adaptive Cruise Control and Forward Collision Warning/Mitigation systems by providing the required road geometry data needed to select the closest in path target and reject all other out of path targets. This same path data can be used in Predictive Adaptive Front Lighting system to bend the headlight in the direction of the upcoming curve. Other map database attributes stop sign location, road class, intersection information, shoulder width, divided/undivided road can also be used in vehicle safety application such as Stop Sign warning system and Lane Departure Warning system. Instantaneous vehicle map based position can be used to identify area of interest that may affect the system performance by government regulation or by poor performance as an output of learning process.

One problem with using a map database for predictive warnings and corrections is that maps contains errors such as curves, jogs, and other features that do not exactly mirror actual road conditions and therefore may trigger unnecessary corrective actions and warnings or miss conditions when a warning is needed for a system that attempts to use the map database as a predictive tool. In addition, a variety of false positives and false negatives can occur with certain map features such as merges, separations, intersections on curves and overpasses, to name a few. Therefore, it would be helpful for any predictive system to identify and predict such errors to eliminate false negatives as well as to be able to determine potential instances of false negatives before the vehicle encounters such areas. It would also be helpful if the system is capable of learning where false negatives exist and preventing unnecessary warnings after the first encounter.

### SUMMARY OF THE INVENTION

In overcoming the above mentioned drawbacks and other limitations of the related art, the present invention provides a system and method of selecting a most likely path of a vehicle from a list of candidate paths. If only one candidate path exists, that path is identified as the most likely path. When multiple candidate paths exist, cost functions determine the weight of various parameters associated with each candidate. Such parameters may include lane information, the vehicle speed, the vehicle travel direction, the lateral speed of the vehicle, the state of various vehicle signals or inputs, such as turn signals, throttle sensors, steering wheel angle sensors and brake light status. From the various weights determined by the cost functions, the candidate path with the highest confidence level is determined to be the most likely path. Based upon the most likely path, the system may proactively search ahead for potential issues and then when applicable, transmit a curve speed warning to alert the driver that the vehicle exceeds a safe speed for an upcoming curve in the road.

The present invention further uses a database structure that allows for easy saving of map errors and processing of predictive warnings for safety systems. The upcoming road is broken into various segments in the map database and each segment includes specific data to allow for easy and efficient analysis of the segments. The system may also look ahead at multiple segments and combine segments into a master segment or set of master segments especially if the vehicle operator has multiple choices of travel paths. From these master segments, a most likely path (MLP) may be created to reduce the required processing power of the system. In general, each segment includes a first and second node point at each opposing end. The length between node points is expected to be stored with the system to easily calculate such length. Along the segment are various data points such as shape points that contain information such as curve radius or other information. These data points may be measured from one of the node ends and include a direction of travel information the system may use to provide predictive warning or active avoidance actions, as some situations may only be applicable in one direction of travel and not the other. To reduce errors, the system may actively review the map database to identify certain map features that may cause predictive errors. In addition, the system may identify certain data points as false negatives, areas where corrective warning is needed based upon previous measured travel or false areas where no positive, corrective warning is needed based upon previous measured travel.

Further scope of applicability of the present invention will become apparent from the following detailed description, claims, and drawings. However, it should be understood that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

The present invention will become more fully understood from the detailed description given here below, the appended claims, and the accompanying drawings in which:

FIG. 1 is a block diagram of a system for warning a vehicle about its curve speed in accordance with the invention.

FIG. 2 illustrates a vehicle moving along a road with an exit ramp.

FIG. 3 illustrates the change in the heading angle of the vehicle of FIG. 2 over time.

FIG. 4 is a block diagram of a cost function for the scenario of FIG. 2 in accordance with the invention.

FIG. 5 depicts a cost function for the lane boundaries of the scenario of FIG. 2 in accordance with the invention.

FIG. 6 is a block diagram of a cost function for the turn signal for the scenario of FIG. 2 in accordance with the invention.

FIG. 7 is a block diagram of a cost function associated with the acceleration/deceleration of the vehicle in the scenario depicted in FIG. 2 in accordance with the invention.

FIG. 8 illustrates another scenario in which a vehicle approaches similar curved branches in a roadway.

FIG. 9 illustrates yet another scenario in which a vehicle may be moving along a highway or a service drive.

FIG. 10 is a block diagram of a cost function to determine whether the vehicle in the scenario of FIG. 9 is on the highway or the service drive when posted/advisory speeds are available from a map database.

FIG. 11 depicts a cost function to determine whether the vehicle in the scenario of FIG. 9 is on the highway or the service drive when posted/advisory speeds are not available.

FIG. 12 depicts a cost function to determine whether the vehicle in the scenario of FIG. 9 is on the highway or the service drive based on lane boundary type information.

FIG. 13 is a block diagram of an exemplary system.

FIG. 14 illustrates an exemplary road condition.

FIG. 15 illustrates an exemplary road condition.

FIG. 16 illustrates an exemplary road condition.

FIG. 17 illustrates an exemplary road condition.

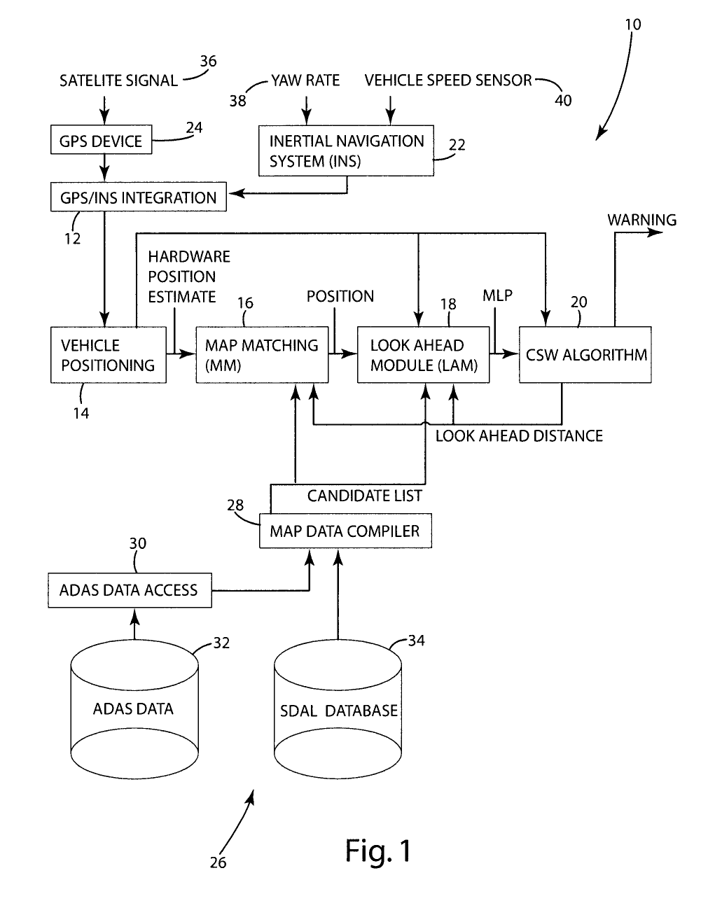

### DETAILED DESCRIPTION OF THE PREFERRED EMBODIMENT

Referring now to the drawings, a system embodying the principles of the present invention is illustrated therein and designated at 10. Accurate real-time positioning is helpful for guidance and is necessary for predictive warning and/or predictive active avoidance systems. As its primary components, the system 10 includes a global positioning system (GPS) and inertial navigation system (INS) integration module 12, a vehicle positioning module 14, a map matching module 16, a look-ahead module 18, and a curve speed warning module 20. The inertial navigation system 22 is also provided with, a GPS receiver 24, a map database 26, and yaw rate module 27 and vehicle speed sensors 29. The map database 26 includes a map data compiler 28 and an ADAS data access 30 that receives information from an ADAS data base 32. The map data compiler 28 also receives information from an SDAL database 34. The map database 26 may be a database that is commercially available. Roads are represented in the map database by multiple connected segments.

The GPS receiver 24 receives satellite information 36 related to the vehicle GPS position. In most vehicles, the GPS or receiver 24 then applies the vehicle's known position to the map database to display the location of the vehicle. In the present invention, the system 10 further uses the current location in combination with the map database 26 to determine potential pathways for the vehicle to follow as described in greater detail below. In the GPS/INS integration module 12, the GPS position is augmented using, for example, a Kalman filter, with the yaw rate 38 and the vehicle speed 40 obtained through the inertial navigation system 22. The information from the GPS/INS integration module 12 is provided to the vehicle positioning module 14, where the vehicle position is calculated in a global coordinate system.

The map matching module 16, implemented with a map matching algorithm, receives the position estimate from the vehicle positioning module 14 and information from the map database 26 to calculate the vehicle position on the map. The look-ahead module 18 then receives the map position information from the map matching module 16, as well as information from the vehicle positioning module 14 and the map database 26, and looks ahead in the map from the calculated map position and calculates the candidate list of probable intended driving paths, in particular, a most likely path (MLP) based on probabilities.

The system may use a variety of methods to determine the MLP, however, it may be desirable to reduce processing requirements through limiting the number of potential paths by limiting the amount of look-forward distance. With the MLP determined, the system 10 may support awareness or warning applications such as curve speed warning, adaptive front lighting, adaptive cruise control, lane departure warning and more. More specifically, the system 10 may provide information regarding the MLP and use that information in combination with other information from various other systems or sensors to provide safety systems with MLP and problematic areas on the MLP.

The MLP is primarily determined by using the look-ahead module 18 to scan ahead for upcoming routes. The look-ahead module 18 may look ahead for a specified distance or until the number of possible paths exceed a preset number of paths. The distance or number which acts as a limit may be set by the processing limits of the look-ahead module, the speed of the vehicle, or a variety of other considerations. To improve the ability of the system to predict the actual path that the vehicle will travel, the look-ahead module may include an input from the navigation system that uses, when available, the directions being provided to the vehicle operator from the navigation system to improve the accuracy of the system in determining the MLP and thereby reducing the number of path probabilities.

The system 10 may also use inputs from other vehicle sensors and other information from the navigation system, specifically the GPS receiver and map database to improve the probability in determining the MLP and reduce the number of path probabilities when a vehicle operator has not entered a destination in the navigation system or to allow the system to determine that the vehicle operator is likely to not follow the provided navigation directions.

The look-ahead module 18 determines the most probable path of the vehicle using, for example, information from vehicle positioning, lane information, lateral velocity, and vehicle signals, such as turn signals, and state. The most probable path and other possible alternate paths can be predicted using the vehicle's travel direction, the direction of the road, the vehicle lane, and the predicted directional change. This information is evaluated using a cost function to weight each parameter with respect to the consideration that the parameter will have toward predicting the vehicle's most probable path.

For example, the system 10 may use the look-ahead module 18 to predict the vehicle's most probable path and other alternative paths by using the vehicle's travel direction, the map database and other vehicle sensors to identify one way, two way and divided roads, as well as highways and vehicle lane data, direction changes, speed or velocity of the vehicle and any other information available from other vehicle sensors such as yaw rate, wheel speed, steering angle, accelerometer, turn signal, brake light status, and other sensors.

The look-ahead module 18 also uses the look-ahead distance to assemble a candidate path subset that is projected out to a selected distance from the vehicle's current position. If only one possible candidate path exists, it will be returned with 100% confidence. Otherwise, a list of all possible candidate paths (and their associated confidence levels) within the look-ahead distance will be calculated to determine the candidate path with the highest confidence level, that is, the MLP.

Provided with candidate list of paths, cost functions assign a total weight for each candidate. The candidate with the higher weight is selected as the MLP. Depending upon the application, different cost functions are used for various scenarios. For each road scenario, there are associated aided signals, or parameters, such as the vehicle lateral velocity, lateral position, turn signal, boundary types, position of the accelerator pedal, and the deceleration of the vehicle. Moreover, each aided signal has a precedence level, such that for each scenario the cost functions are calculated in ascending precedence beginning with precedence 1. If a particular cost function determines a weight greater than about 0.5, then the system 10 does not employ the cost function of the next precedence.

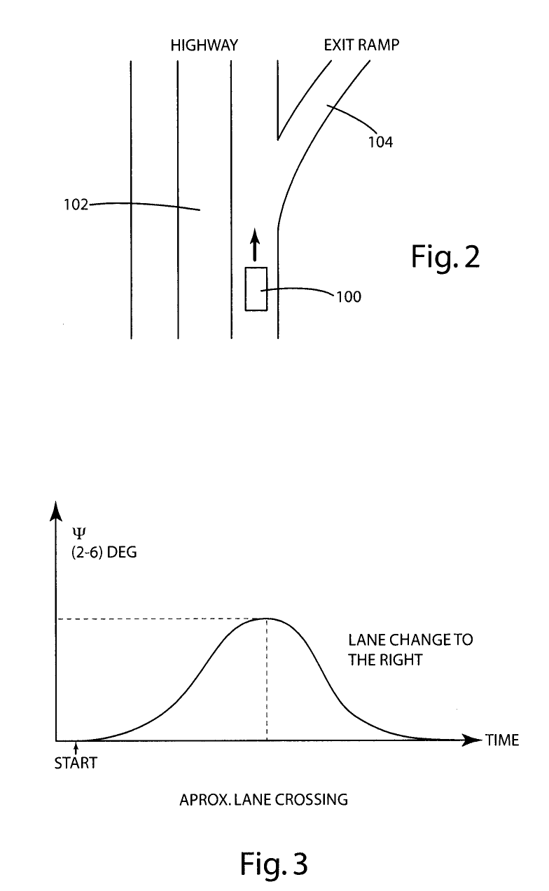

For example, a scenario is shown in FIG. 2 in which a vehicle 100 is moving along highway 102 with an exit ramp 104. Here, the lateral velocity v_{Lat} and the lateral position d_{Lat} have a precedence level 1. In this situation, the look-ahead module 18 detects a lane change by the vehicle 100 toward the upcoming exit ramp 104. To achieve this, the lateral velocity is defined as

v_{Lat}=d_{Lat}v*^{Ψ} (1)

where v_{Lat} is the rate of change of the lateral position, v is the vehicle speed, and Ψ is the heading angle of the vehicle with respect to the road.

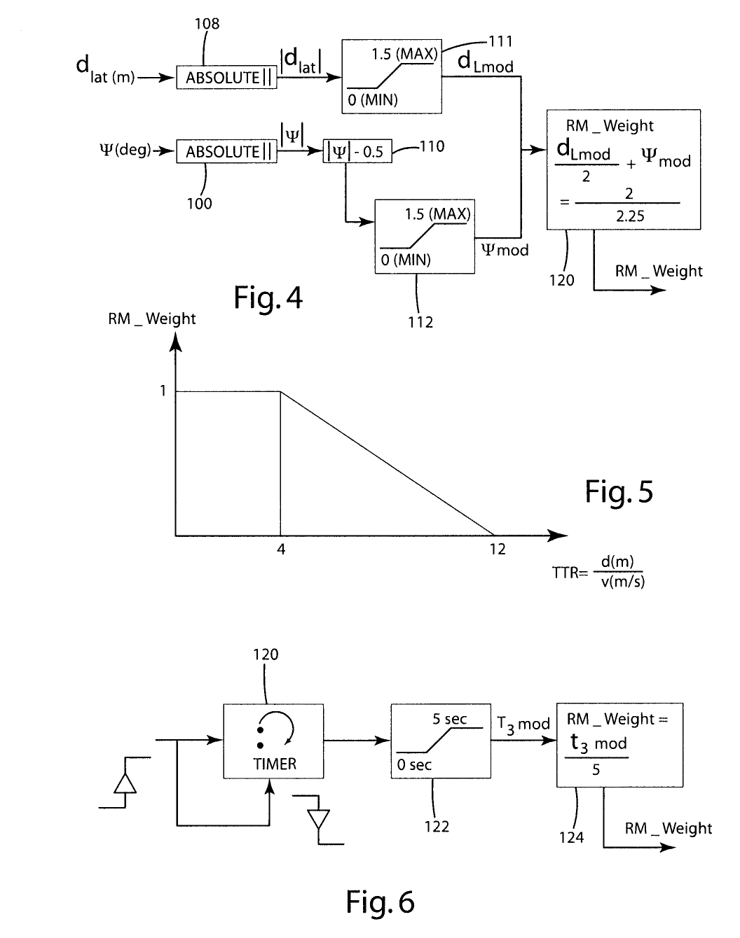

The behavior of the heading angle Ψ during a lane change is shown in FIG. 3. The lane keeping behavior produces a heading angle Ψ the range of, for example, ±0.5 degrees. Therefore, this angle can be used as a factor in the ramp cost function weight (RM_Weight) when its absolute value exceeds, for example, 0.5 degrees. However, this factor may not be able to detect a very slow lane change. To overcome this, the cost function fuses the lateral velocity measurement with the lateral distance position as shown in FIG. 4, where

$$ψ ( deg ) = \frac{{v}_{Lat} ( m / s )}{v ( m / s )} * \frac{180}{Π} , \qquad ( 2 )$$

if the lateral distance is measured in meters (m) and the heading angle is determined in degrees. Specifically, the absolute values of Ψ and d_{Lat} are determined in modules 106 and 108, respectively. Then in module 110, a predefined value, such as 0.5 degrees, is subtracted from the absolute value of the heading angle. Modified values of the lateral position d_{Lmod} and the heading angle Ψ_{mod} are determined in respective limiter modules 111 and 112, so that regardless of the input values to the modules 110 and 112, the outputs from these modules will be within the defined minimum (min) and maximum (max) values. The RM_Weight is then calculated according to a predefined expression as shown in a module 114.

Information about the boundary type is assigned a precedence level 3. If the boundary type of interest is solid, or if both boundary types are solid, the RM_Weight is determined as a function of the time to reach (TTR) the ramp 104 (FIG. 2) as shown in FIG. 5. That is, for a TTR less than 4, the RM_Weight is 1, for TTR equal to or greater than 4, the RM_Weight decreases linearly from 1 to zero when the TTR equals 12.

The time the turn signal is on is assigned a precedence level 2. In particular, as shown in FIG. 6, a resetable timer module 120 determines the length of time the turn signal is on. This information is forwarded to a limiter block 122 which provides a modified T_{smod} to the calculation module 124 which in turn calculates the Rm_Weight using the expression associated with that module. Thus, in sum, the weight of the turn signal is a function of the time the turn signal is on. If this time is, for example, 5 seconds, the weight of the signal reaches its maximum value of 1.

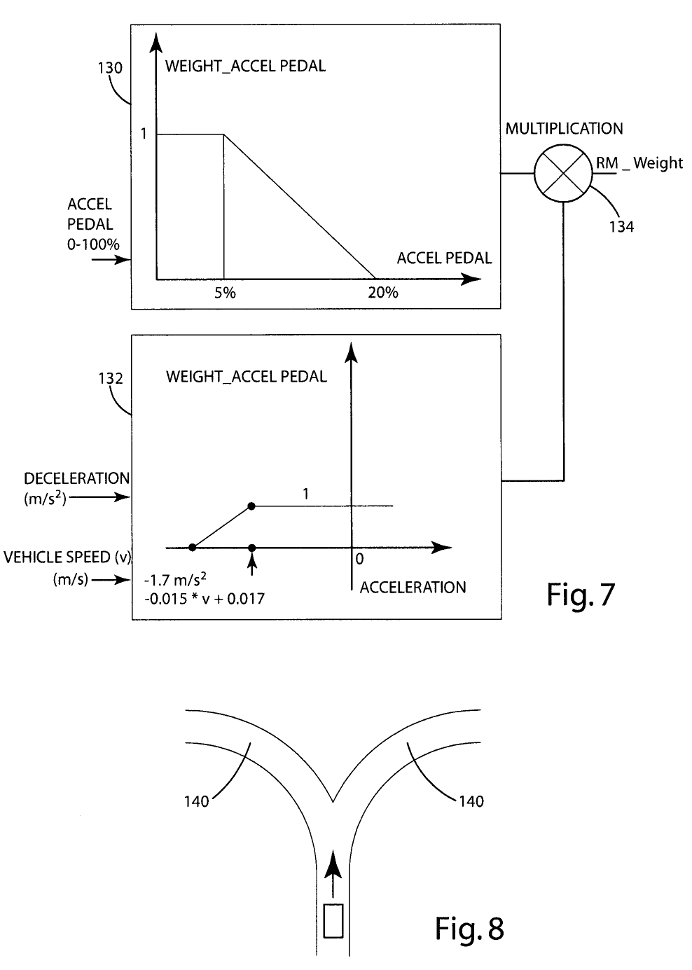

Turning now to FIG. 7, the deceleration or acceleration of the vehicle is assigned a precedence level 4. When the driver's foot is on the accelerator pedal, the driver is either trying to maintain the current vehicle speed or accelerate the vehicle. To decelerate, the driver's foot is taken off the accelerator pedal. The gas pedal status is expressed in the accelerator pedal percentage module 130. In order to distinguish between the deceleration as a result of a vehicle decelerating in front of the host vehicle and the deceleration associated with an upcoming ramp, the weight of the accelerator pedal is proportional to the magnitude of the vehicle deceleration. The deceleration signal is estimated by the algorithm implemented in the CSW module 20 and is forwarded to the look-ahead module 18. Thus, in the present implementation, the module 130 generates a cost function weight RM_Weight of 1 when the accelerator pedal percentage is less than about 5%. If it is above 20%, the weight is zero. However, this weight is modified by a module 132 associated with the vehicle acceleration, that is, the values of the modules 130 and 132 are multiplied together in a module 134. In this implementation, if the vehicle acceleration is less than about 1.7 m/sec₂, the weight from the module 130 is multiplied by zero, such that the final RM_Weight is zero. If, however, the acceleration is more than the value of the defined function (−0.015*v+0.17), where v is the vehicle speed in m/s, the weight from the module 130 is multiplied by one, such that the final weight RM_Weight is 1. Note that this RM_Weight has a value if the deceleration occurs while the vehicle is on a lane that has a solid boundary type or a missing boundary (or both boundary types are solid). Therefore, this ramp weight is multiplied by the weight function shown in FIG. 5.

Scenarios involving forked roads, such as those identified at 140 in FIG. 8, are quite similar to those involving exit ramps (FIG. 2), such that the same cost functions in ascending precedence can be used. Note that when the upcoming curved road segments are similar, that is, the segments have about the same curvature and about the same posted advisory speeds, the deceleration-aided signal (FIG. 7) is not employed.

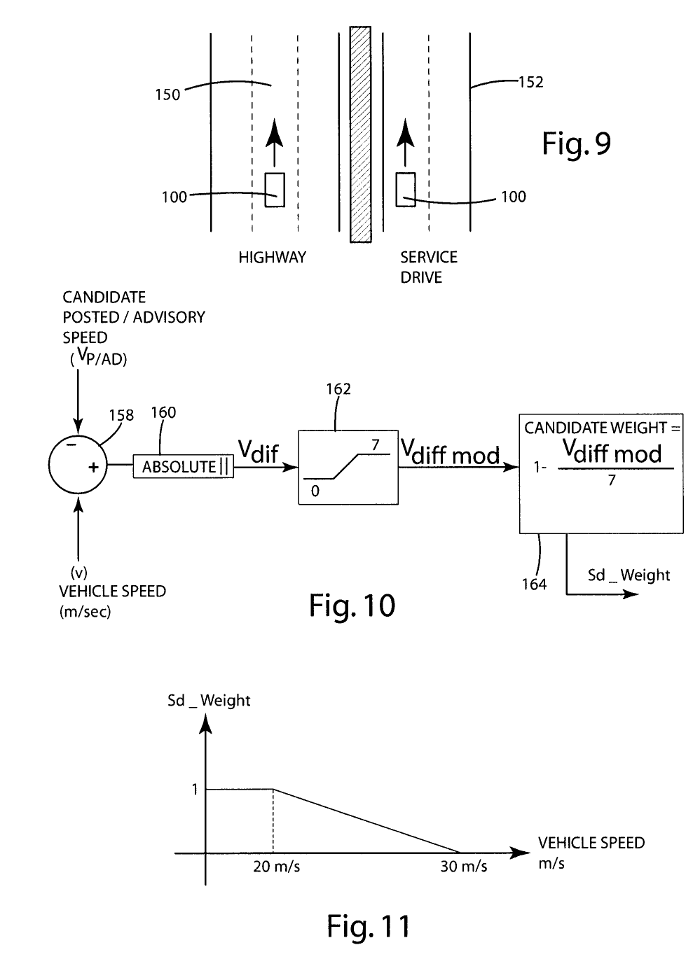

Another scenario, as shown in FIG. 9, involves deciding whether the vehicle 100 is on a highway 150 or on a service drive 152 using aided signals such as the posted/advisory speed, the vehicle speed, and road boundary types. This aids in locating the vehicle on the appropriate road, and therefore to extract the correct candidate set. If a posted/advisor speed VP/AD exits for the candidate road exists in the map database 26, the cost function shown in FIG. 10 is employed and assigned a precedence level 2. This cost function can be employed in any situation to help locate the vehicle on the correct road.

Specifically, the absolute value of the difference (as determined in 158) of the vehicle speed v and the V_{p/AD} is determined in a module 160. This difference v_{diff} is forwarded to a limiter 162 to calculate a modified difference v_{dif mod} which in turn is transmitted to a calculation block 164 to determine the service drive cost function weight (SD_Weight) employed. Thus, if the absolute difference between the vehicle speed and the posted advisory speed is greater than 7 m/sec, the weight of the road candidate is zero.

If a posted/advisory speed is not available, the cost function shown in FIG. 11 is employed, where it is assumed that the average vehicle speed on a highway is greater than on a service drive. In this case, if the vehicle speed is less than 20 m/s, the weight is one. As the speed increases from about 20 m/s to about 30 m/s, the weight decreases from one to zero.

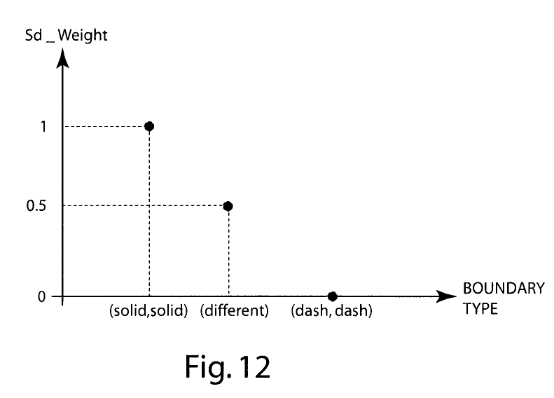

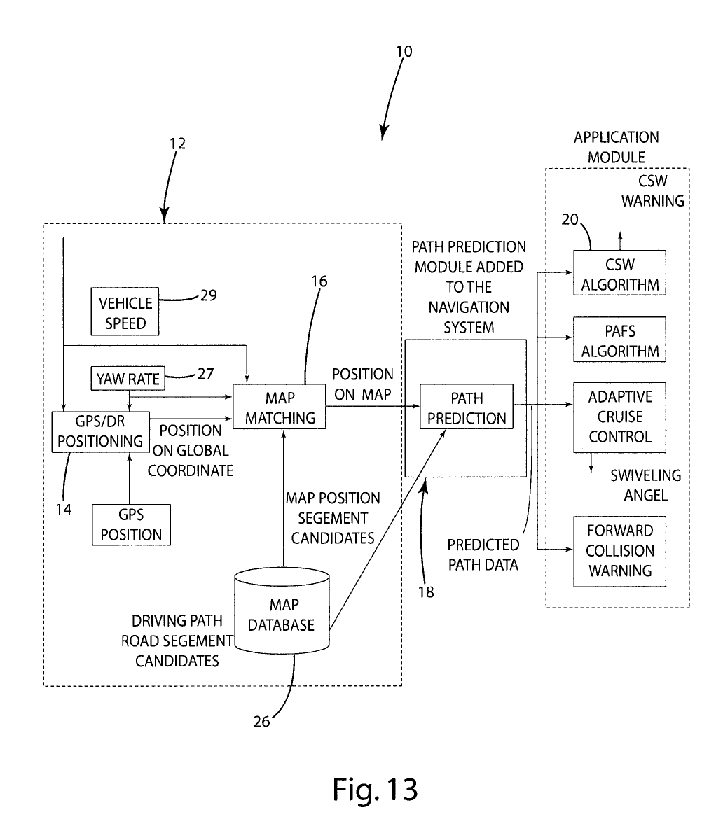

If the left and right boundaries are solid, it is probable that the vehicle path is a service drive. If the boundaries are dashed, it is probable that the vehicle path is a highway. Therefore, the cost function shown in FIG. 12 is employed, such that, if the vehicle is on a service drive, the weight is one, and if the vehicle is on a highway, the weight is zero. If one boundary is dashed and the other is solid, the weight function is 0.5.

Moreover, an estimate of the instantaneous curvature can be used to modify the confidence in the current selected road and help in predicting the future vehicle position for a limited distance ahead. This estimate is performed in the algorithm implemented in the CSW module 20 and passed to the look-ahead module 18. This curvature estimate is compared with the instantaneous curvature coming from the map database. The difference between the two curvature values contributes to the confidence in the current selected road. The weight of the cost function varies inversely with this difference.

In a preferred implementation, the system 10 initially determines if the vehicles is on a highway or a serviceway by determining the weight according to the cost function shown in FIG. 12. If the weight is less than about 0.5, the system 10 employs either the cost function shown in FIG. 10 if the advisory speed is posted or in FIG. 11 if the advisory speed is not posted. If either of these functions determines a weight greater than about 0.5, than the vehicle is likely on a service road. Otherwise, the vehicle is driving along a highway.

After the system 10 determines the type of road on which the vehicle is moving, the system employs the cost functions in ascending precedence shown in FIG. 4, FIG. 6, FIG. 5, and FIG. 7. As each cost function is employed, if that cost function determines a weight greater than about 0.5, then the system 10 assumes that the vehicle is likely approaching an exit ramp to determine the most likely path, and thus there is no need to proceed to the next cost function. If the weight is less than about 0.5, then the system 10 proceeds to use the next cost function. Note again, that if the system 10 uses the cost function shown in FIG. 7, the weight calculated from that cost function is multiplied by the weight calculated from the cost function of FIG. 5. If the cost functions of FIG. 4, FIG. 6, FIG. 5, and FIG. 7 all determine that the respective weight is less than about 0.5, than the system 10 assumes the vehicle is not approaching an exit ramp.

Once the MLP is determined, a curvature calculation algorithm residing, for example, in the look-ahead module 18, evaluates the most likely path to determine the curvature values, which, along with the vehicle speed from the vehicle positioning module 14, are passed to the curve speed warning module 20. A threat assessment algorithm implemented in the curve speed warning module 20 assesses the threat to the vehicle and makes a warning decision 44.

The threat assessment algorithm in the curve speed warning module 20 evaluates the curvature values from the look-ahead module 18 to assess the potential threat of the calculated curvature of the road based on a cost function that takes into consideration, for example, the vehicle speed, the estimated projected speed profile, the travel distance to the curvature point, the curvature, the estimated road conditions, and the driver reaction time. The estimated road conditions may be calculated from the vehicle's signals, such as brake signals, turn signals, ambient temperature, and wiper functions. The curve speed warning system 20 then initiates a warning level based on the calculated threat level.

The system 10 may easily be used to provide warnings about upcoming curves, jogs or bends in the road, in particular, the relationship of the speed of the vehicle to the vehicle's safety within those curves, jogs or bends in the road. For example, the system uses the navigation system, in particular, the GPS receiver 24 to place the vehicle's position within the map database. The system then determines the MLP and performs curvature calculations based upon the geometric data of the MLP and then performs a threat assessment based on vehicle speed and expected road curvature. The above calculations may also be used by predictive lane systems.

Current commercial map databases are designed for navigation purposes. The accuracy of these maps is sufficient for navigation in a large variety of road scenarios. As described above, they sometimes fail in such situations as service drive/highway, highway/exit ramp, fork, complex overpasses, and mountain area/single road. All of these scenarios could lead to placing the vehicle on the wrong road or off the road.

Absolute and relative accuracies have been improved by the continuing replacement of the older map database shape points with higher quality advanced driver assistance system (ADAS) shape points. However, the accuracy of the ADAS map is still inadequate in many of the branching scenarios and scenarios in which three-dimensional information is required.

For path prediction algorithms, a map accuracy level that places a vehicle on the wrong road segment leads to an incorrect set of the road candidates, which produces the wrong MLP. In cases where the correct vehicle position is available, relative accuracy is the determining factor in path prediction. An accurate relative placement of the shape points along the MLP means an accurate curvature distribution along this path.

The rules and methods of creating the map database (ADAS or older) can lead to very low relative accuracy in some road scenarios. An example of that is the “connectivity rule,” which requires addition of extra shape points just for connectivity purpose, for example, to provide continuity between road segments or different roads. These added shape points are not part of the road geometry and can lead to incorrect curvature values along the path. Other rules, such as the “merging rule” in connecting a divided road with an undivided road or vice a versa or connecting an on-ramp with a main road, can also lead to a misleading representation of the path geometry.

Thinking of the map as a sensor requires, as with any other sensor, having its error sources defined and modeled. Therefore, a corrective/updating capability to compensate for the changing nature of the roads and associated driving restrictions is helpful. Furthermore, additional types of information, such as height and super elevation data, are useful to extend the usage of the map for other automotive applications.

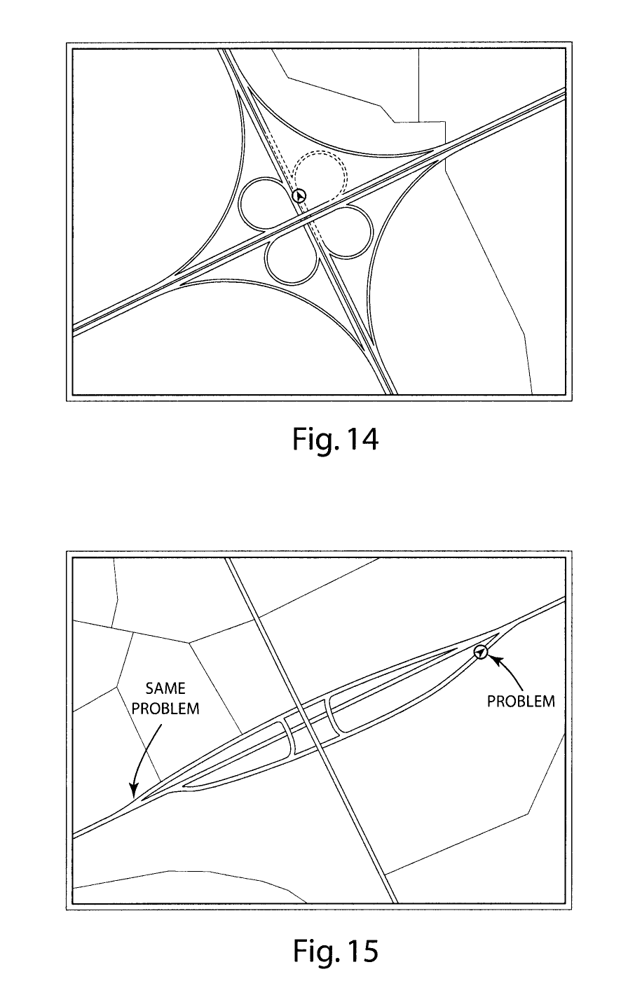

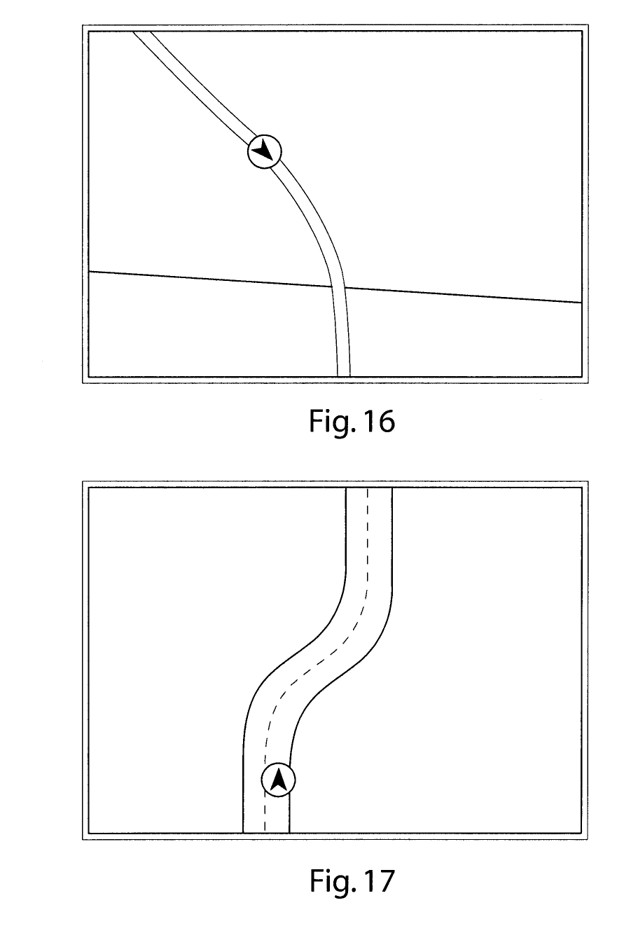

The sensing capability of a map provides detailed information about the instant road segment and the upcoming road segments. FIG. 14 shows an example of this in which a vehicle (arrow inside the circle) is approaching an exit ramp branching. The double dashed road is Path 1, which consists of two segments: the segment that the vehicle is currently on (segment before branching), and the straight (highway) segment after branching. The double dashed road segment followed by a dot-dash segment is Path 2, which also consists of two segments: the segment that the vehicle is currently on (segment before branching and represented by a portion of the dashed line), and the curved (ramp) segment after branching represented by the dot-dash segment.

The path set in FIG. 14 exemplifies how the navigation unit may output the map sensor data. The path data could be described by a number of curvature points along a look-ahead travel distance of the corresponding path. Each curvature point can be described by global latitude and longitude coordinates, vehicle centered true north/east coordinates, curvature value, confidence value, number of lanes, and travel distance from the vehicle location.

While a variety of methods may be used to organize data within the database, and the type of data stored may vary, the present invention found the following method and data useful in accomplishing the above-described functions. At a minimum, it is expected that the map database will break the roads into manageable segments, each with identifiable segment id. The specifics of the segment id's may be database specific and only need to be able to identify individually the segments of the roads. It is expected that any location of a vehicle will reside on one of the road segments however, the MLP or possible paths may encompass multiple road segments.

Each road segment is associated with at least one node point. The node point identifies one end of the segment such as by a stored GPS coordinate or other method. The database may also contain the node point of the other end of the segment. It is expected that both node points on each of end of the segment would typically be stored because as one segment ends, the other starts. For example, if only the left node was associated with each road segment by default the right node point of a particular node segment would be also the left node point of the adjacent segment.

The length of each road segment may be calculated or may be stored in the database. At specific points along a segment, various points of interests (POIs) or a point of interest (POI) may occur. For example, these POIs may identify map errors or other items of interest to be used by the system. These POIs may need more data than what is typically available (latitude, longitude, altitude) in most navigation or avoidance systems. For example, a POI may only be a POI in one direction and not the other, such as for an undivided road, the road is represented by one line (connected road segment) for both travel directions. The POI may only reside in one segment and if the POI happens at the junction of two segments, it is expected that two records may be added to the database for each road segment. Of course, it may be only one POI entered for one segment even though it sits at the junction because the POI may be only applicable to travel in a particular direction. The segments are indexed by their segment ids which allow for multiple fragments within the segment in multiple POIs in the segment.

A fragment within a road segment is the distance from one of the node points to the POI within that segment. As POIs are directional with a stored direction of travel, or defined as a length from one of the node points, the same location may have more than one POI in the database. For example, two POIs may occur on a road, one for each direction of travel. If multiple POIs occur within the same segment, which creates multiple fragments, it is expected that the fragments are sorted by the distance from the end node, in other words, in order of which they would occur as the vehicle progresses in the direction of travel. This ensures that a single POI is not treated as multiple POIs, such as when the system determines an error in the map database, only one POI is created the first time and no additional POIs when it is re-encountered.

The system 10 may also be configured to adjust the POI location or the length from the node point to allow for errors common in GPS receivers and prevent multiple POI's being created for the same error when the GPS receiver shows a slightly different coordinate position the next time the error is encountered. For example, the system may lengthen a fragment stored in length or change the coordinate position of the original POI. As is well known in the art, GPS receivers are accurate within a certain range and also other interferences such as trees, hillsides, mountain ranges may increase the amount of expected air range. Therefore, it is expected that the range of error allowed before a new POI is creates is related to the expected error in the GPS receiver as well as the expected error in the map database and in some circumstances, the combined maximum error of the GPS receiver and map database. Although it is preferable to only store information regarding the last encounter in the GPS system, as processing power improves as well as memory characteristics, it may be desirable to store each encounter with a particular POI and then average the location to adjust for errors. This is particularly helpful in mountainous or forested regions where the GPS receiver may have a greater error than normal and by averaging the amount of error it increasingly provides a better location for the expected encounter with a POI.

A variety of methods may be used to store the POI files against the map database, however, it is expected that to save the processing time and not interfere with the system, a new POI may be at least temporarily stored in a separate file that will be used later to update the main database. Of course, the POI could be stored at the end of the main database file and then later updated into the map database in the correct order. In this way, the POI and associated information is saved even if a system failure such as a power failure occurs before the database is updated. At a later time, it allows the POI to be added into the database and the database configured for quick searching and calculations along particular road segments.

As described above, each road is divided into multiple segments, unless of course the selected road is of such length that only one segment is needed. Examples of roads that only need one segment may be subdivision streets that are very short or cul-de-sacs and courts as well as some dead-end roads.

As further described above, each segment is defined at the ends by node points. As many roads are not perfectly linear, between the node points and along the segments may be a number of shape points. Shape points define the shape of the road. A substantially linear road would include few, if any, shape points while roads with curves would include more shape points. The more curves or changes from linear in a particular road segment, the more shape points are needed to define or describe the road. Also, as the curvature of the road increases for a particular curve such as a very shape curve, the number of shape points is expected to also increase. More specifically, shape points are a set of points with location data, latitude, and longitudinal coordinates, and as application other data. Generally, shape points and node points include similar data and may even include identical data. Node points may include additional data such as speed limit, lane categories, single or multi-digitized roads, road classes and any other helpful data.

In operation, the system must calculate probably paths and typically, if possible, calculate the MLP. In calculating the MLP, the system uses the map database and, starting from the current vehicle position, looks a meaningful distance ahead, typically a function of vehicle speed. In some cases, the distance may be further limited to prevent too many paths from being considered. Of course, the system may also limit some paths based upon various vehicle inputs and GPS and map database inputs such as the speed of the vehicle. While the system generally does not use the speed signal to help select the MLP, as it may prevent accurate selection of CSW, it may be used to help in selecting the current vehicle position, such as whether the vehicle is traveling along highway versus service drive, when combined with some map attributes and the GPS is not clear as to the location. Other inputs that help limit paths are lane position of the vehicle or any other data that shows that it would be unlikely or improbable that the operator would choose a particular path. Those unlikely or improbable paths may be eliminated from consideration. More specifically, the system may eliminate all branch paths within a set number of feet from the current vehicle position depending on the vehicle speed. For example, a vehicle in the left turn lane of a road with a left turn signal activated would continue in a straight path or in a path to the right. This logic tree allows the system to extract all probable upcoming road segments without wasting processing power. Because of the expediential growth in potential paths that each branch point, the system may limit the number of branch points being considered as being probable.

As stated above, the upcoming road segments are filtered through possible driving paths. The possible segments are connected into multiple master segments. These master segments may also be further limited to save processing power. One method of limiting these master segments is to pick three segments with the highest probability in different directions of travel. For example, the system may pick a master segment along a straight path, a master segment along a left path, and a master segment along a right path. By choosing left and right paths of course the vehicle as part of the left and right master segments may continue straight for some distance pass minor branches to a major branch and then use the major branch as either a left or right road segment that becomes a left or right master segment when all of the road segments are combined. Basically, the system would select the straight path, the left path, and right path of the highest probability to create the master straight, master left and master right paths.

The system then determines the most probable intended driving path from the master segment by calculating the probability of continuing straight, right or left from the current position using vehicle inputs from the map database, directions to an inputted address or any other helpful information. For example, the system may use vehicle sensor inputs such as yaw rate, steering angle, turn signal status, brake lights status, throttle signal, speed, wheel speed, as well as from the navigation system, calculated or intended route, road attributes including the number of lanes, road type or class, road name, lane markings, and more. Although not required, the system may also be configured to be a learning system and assigns a probable value to a previously traveled pass that is higher than the probable value assigned to other paths. More specifically, the system would determine that previously traveled paths are the more likely travel path that the vehicle actually takes. The system may also keep track of how many times each probable path is taken. Once the system defines the most likely path, the other master segments may be ignored to save processing power and the system may focus on determining the curvature and other features of the MLP.

Using the shape points that are part of the master segment, the system can calculate any upcoming curves. Typically, the system for continuity will analyze forward in the direction of travel from the last known position of the vehicle. Any desired data and attributes for the MLP are calculated and a curvature value is assigned to the shape points. The system will interpolate between any shape points for example using a clothoid road model. A clothoid road model assumes that the curvature change is linear with distance. The system then adequately represents the MLP to determine the curvature of the MLP. New curvature calculations and attribute updates are only performed when a new segment is added to the master segment that in turn forms the MLP, but in some cases may switch the MLP to another master segment due to a change in input such as turn signal, status light, or brakes and any other vehicle inputs.

While the above describes how paths are selected to allow for avoidance or warning systems to operate, the system needs accuracy to minimize warnings to the situations when they are needed or the operator may start to ignore warnings due to the number of false warnings. For example, if the system reacts to each error in the map database or in situations such as overpasses, road merges and others that are problematic to identify due to the shape points, the operator would likely start to ignore the system. Therefore, the system needs a way to correct for errors in the map database as well as special situations in the map database that would normally create warnings or cause the car to actively engage some safety characteristic.

While one way to correct for errors is to download new updates to the map database, most map databases will always have errors no matter how recent the map database is. Map databases are put together from huge amounts of data and it is common for the map database to include errors. It is also very difficult for map-makers to identify and correct these errors, as there is no system in place to receive feedback from the average driver. Some of these errors in the map database may be due to the rules and algorithms that create the shape points within the map database also.

As described below, the system generally will create and save POI's where errors occur such that the warnings are not provided to the vehicle once the error messages are received the first time and the system determines that the warning message was provided in error. Although not required, the system may optionally save POI's and provide data back to map-makers where errors occur so that map databases may be improved over time.

Other errors in the map database are created due to the changing nature of roads. For example, a road may be straightened to a more gradual curve but the database may include still shape points that define a sharply curved road. As another example, a road may be illustrated as ending in the map database but was later extended. As roads are constantly under construction and the map databases are only updated later in response to these constructions, many errors in the map database will always be found.

Also, for some types of roads, the rules and methods for creating the map databases can lead to very low accuracy. For example, map databases may require extra shape points just for connectivity purposes. For example, to provide continuity between road segments of different roads, these added shape points are not part of the road geometry and can lead to incorrect curve values along the path. Other issues with map databases include roads that merge, such as connecting or separating between divided and undivided roads, or connecting on and off ramps with divided highways and other roads. Some databases also create errors when dealing with overpasses, road merges, traffic circles, special intersections such as an intersection on a curve, changes in the number of lanes on a road or interstate, or overpasses.

As more detailed examples of the above, overpasses create unnecessary extra shape points for connectivity purposes which in turn lead to high curvature value while there may be little to no curve. In regard to road merges, the shape points at the merge or intersection of roads can create high curvature values at the merge, which define the curve much more sharply than the actual curve or merge. The map database generally also represents the center of the road and therefore when the road divides or shifts from divided to undivided, the center of the road may suddenly shift and the split may result in curvature values that are not representative of the road's actual curvature. This system is configured to identify these instances in the map database and suppress warnings that are created. Therefore, overpasses, merges, divides, special intersections may be easily identified from the system as the system may suppress the warnings that would normally be errors as commonly referred as false negatives.

To work properly, the system must also detect map errors that occur randomly and errors where they are not expected. By storing the location of the error in the database in the system generally including the direction of travel along the particular segment, the system will only give the error such as a warning the first time that it is encountered and thereafter with suppressed warnings at that location.

As a person skilled in the art will readily appreciate, the above description is meant as an illustration of an implementation of the principles this invention. This description is not intended to limit the scope or application of this invention in that the invention is susceptible to modification, variation and change, without departing from spirit of this invention, as defined in the following claims.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

What is claimed is:

1. A system for determining the most likely driving path of a vehicle moving along a roadway from a list of candidate paths, comprising:
a map database;
a map matching module which determines the vehicle's position on a map associated with the map database; and
a look-ahead module which determines a list of candidate paths and wherein the system is configured to receive vehicle inputs and wherein the look-ahead module is capable of analyzing the vehicle inputs to determine the most likely path of the vehicle.

2. The system of claim 1 wherein the vehicle inputs are selected from the group consisting essentially of turn signal status, vehicle speed, steering wheel position, wheel angle, brake light status, and throttle position.

3. The system of claim 1 wherein the look-ahead module is implemented with different cost functions associated with various roadway scenarios the vehicle potentially encounters.

4. The system of claim 1 further includes a vehicle positioning module capable of determining the vehicle's position and wherein the map making module receives the vehicle's position from the vehicle positioning module.

5. The system of claim 4 wherein the look-ahead module receives a destination input from a navigation module as one of said vehicle inputs.

6. The system of claim 5 wherein the look-ahead module uses said destination input to eliminate candidate paths.

7. The system of claim 4 wherein said look-ahead module assigns a probability to each candidate path.

8. The system of claim 1 wherein the system provides an output to a vehicle safety system regarding an expected condition along the most likely path of the vehicle.

9. The system of claim 8 wherein the vehicle safety system is selected from a group of systems including curve speed, warning systems, stability systems, adaptive front light systems, adaptive cruise control systems, forward collision warning/mitigation systems, skid control systems, lane departure warning systems and driver awareness systems.

10. The system of claim 1 wherein the one or more of the vehicle inputs includes the vehicle speed and the posted speed for the roadway from the map database to determine if the vehicle is on one of a service drive, and a highway.

11. The system of claim 1 wherein the system includes a detection and correction module which identifies and adds points of interest to the map database.

12. The system of claim 11 wherein the point-of-interest is determined using positioning system, the map database and a vehicle safety system.

13. The system of claim 12 wherein the point-of-interest represents a false negative in the vehicle safety system.

14. The system of claim 12 wherein the point-of-interest represents a false positive in the vehicle safety system.

15. The system of claim 11 wherein said point-of-interest is one of a shape point and node point in the map database.

16. The system of claim 1 wherein the map sensing module is configured to provide information and data about instantaneous and upcoming road segments.

17. The system of claim 1 wherein the map database includes multiple road segments and wherein the possible road segments are connected into multiple master segment.

18. The system of claim 17 wherein each road segment is assigned a probability and the segment with the highest probabilities are connected into said multiple master segment.

19. The system of claim 17 wherein at specific locations, points-of-interests are added to selected road segments.

20. The system of claim 19 wherein said system adds said points-of-interest and said added points-of-interest are not previously in the installed map database, until added by the system.

21. The system of claim 19 wherein said points-of-interest identify map errors.

22. The system of claim 19 wherein said points-of-interest include location data.

23. The system of claim 22 wherein said points-of-interest include direction of travel data.

24. The system of claim 19 wherein each point-of-interest is given a unique ID and indexed by said unique ID.

25. The system of claim 24 wherein said segment ID's allow for multiple fragments within the segment when the segment includes a point-of-interest.

26. The system of claim 25 wherein said fragment is the distance between the node point on the segment and the point-of-interest.

27. The system of claim 26 wherein the fragments are sorted by distance from the node of a segment.

28. The system of claim 27 wherein the fragments are sorted by direction of travel.

29. The system of claim 19 wherein a single location may include multiple points-of-interest on a segment.

30. The system of claim 29 wherein said multiple points-of-interest at said single location each have a stored different direction of travel.

31. The system of claim 19 wherein the system is configured to not store a new point-of-interest when the direction of travel matches a previously stored point-of-interest on the current road segment and when the new point-of-interest is within a specified distance of the previously stored point-of-interest.

32. The system of claim 31 wherein the new point-of-interest is not stored only if the relevant data related to the point-of-interest is substantially identical to the relevant data of the previously stored point-of-interest and wherein said relevant data is not direction of travel data and is not location data.

33. The system of claim 1 wherein the road includes the ability to travel to at least of two of the left, right and straight directions, and wherein the ability to travel to the left, right and straight directions may have multiple available travel paths, and the system selects the straight travel path, the left travel path, and right travel path of the highest probability to create the master straight, master left and master right paths.

34. The system of claim 33 wherein the system then determines the most probable intended driving path from the master segment by calculating the probability of continuing straight, right or left.

35. The system of claim 33 wherein if a single travel path in one of the left, right and straight directions exists, the system automatically selects that single path as having the highest probability in that direction.
